(19) United States
(12) Patent Application Publication
(10) Pub. No.: US 2019/0313597 A1
(43) Pub. Date: Oct. 17, 2019

(54) FOLDING PET CARRIER

(71) Applicant: LI-CHEN CHEN, Tainan City (TW)

(72) Inventor: LI-CHEN CHEN, Tainan City (TW)

(21) Appl. No.: 16/183,739

(22) Filed: Nov. 8, 2018

(30) Foreign Application Priority Data
Apr. 11, 2018 (TW) 107204670
Jul. 13, 2018 (TW) 107209496

(51) Int. Cl. A01K 1/02

(52) U.S. Cl. CPC A01K 1/029; A45F 3/04; A01K 1/0272; A01K 1/0254

(57) ABSTRACT

A folding pet carrier includes a back panel, a bottom panel, a front panel, a top surface portion, and two side panels. A lever device disposed at an inner side surface of the back panel includes a telescopic rod body and a handle portion disposed at an upper end of the telescopic rod body. The lever device extends to the outer side of the top surface portion or is hidden under the top surface portion. Rollers are disposed on a bottom surface of the bottom panel. Two straps are disposed on two sides of the back panel. A connecting member is disposed between side edges of the side panels, the bottom panel, the front panel, and the top surface portion. The folding pet carrier can be stowed by folding the two side panels, the top surface portion and the front panel to be stacked on the back panel.

### CROSS-REFERENCE TO RELATED PATENT APPLICATION

This application claims the benefit of priority to Taiwan Patent Application Nos. 107209496 filed on Jul. 13, 2018 and 107204670 filed on Apr. 11, 2018. The entire contents of the above identified applications are incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a folding pet carrier, and more particularly to a folding pet carrier used to carry pets out or on public transportation.

### BACKGROUND OF THE DISCLOSURE

Pet owners often use pet carriers or pet strollers to carry their pets on outings or onto transportation vehicles. However, most conventional pet carriers or pet strollers are uni-functional. For example, pet carriers can roughly be divided into portable carriers or backpack carriers. The portable carriers are mainly carried by hand, while the backpack carriers are mainly carried on the back of the user. These kinds of pet carrier must be carried by manpower, and cannot be wheeled on the ground, causing a physical burden to the user.

On the other hand, pet strollers can only be wheeled on the ground and cannot be carried by hand or on the back. The pet carrier on the pet stroller is usually combined with the pet stroller and cannot be used alone. Therefore, the pet strollers cannot be brought onto transportation vehicles, and cannot easily enter narrow indoor spaces.

Because of the structural and functional limitations in conventional pet carriers and pet strollers, pet owners have to be prepared to use different types of pet carriers and pet strollers, which is inconvenient and increases the financial burden on pet owners.

Furthermore, most conventional pet carriers adopt a fixed structure and cannot be folded. The pet carrier is space-consuming when not in use, and the transportation of the pet carrier is extremely inconvenient, such that the pet carrier is not only difficult for the pet owner to carry, but quite space-consuming during delivery from the manufacturer to the sales point.

Based on the above, it has become important in the art to solve the aforementioned issues by improving the structural design of the conventional folding pet carriers.

### SUMMARY OF THE DISCLOSURE

In response to the above-referenced technical inadequacies, the present disclosure provides a folding pet carrier.

In one aspect, the folding pet carrier includes a back panel, a bottom panel, a front panel, a top surface portion and two side panels. The back panel, the bottom panel, the front panel, the top surface portion and the two side panels surroundingly define an accommodating space. The two side panels are connected to two opposite side edges of the back panel, and the two side panels and the two side edges of the back panel are connected via a bendable connecting portion to allow the two side panels to be bent from the position of the connecting portion. The bottom panel is bendably connected to the bottom of the back panel. The front panel and the top surface portion are formed of flexible cloth or a sheet material such that the front panel and the surface portion are foldable. A connecting member is respectively disposed between edges of the two side panels and the bottom panel, the front panel and the top surface portion, and a user can close or open the two connecting members. When the two connecting members are closed, the edges of the two side panels and the bottom panel, the front panel and the top surface portion are connected with each other via the two connecting members. When the two connecting members are open, the edges of the two side panels and the bottom panel, the front panel and the top surface portion are separated, allowing the two side panels, the bottom panel, the top surface portion and the front panel to be stacked on the back panel, so that the folding pet carrier can be stowed.

In certain embodiments, the folding pet carrier further includes a lever device, a plurality of rollers, and two straps. The lever device is disposed at an inner side surface of the back panel and includes a telescopic rod body and a handle portion disposed at an upper end of the telescopic body. The telescopic rod body and the back panel are disposed at the inner side surface of the back panel in parallel, and the telescopic rod body is extendable or contractible along a direction parallel to the back panel. When the telescopic rod body contracts, the height of the upper end of the telescopic rod body and the handle portion is lower than the height of the top surface portion and hidden under the top surface portion. When the telescopic rod body extends, the upper end of the telescopic rod body and the handle portion extend to the outer side of the top surface portion. The plurality of rollers are disposed on the bottom surface of the bottom panel. The plurality of rollers are in contact with the ground to allow the folding pet carrier to be wheeled on the ground. An upper end of the two straps is connected to an upper side edge of the back panel. A strap hook is respectively disposed at a lower end of each of the two straps. Two strap hook loops are respectively disposed at two sides of the outer side surface of the back panel near a lower end of the back panel. The two strap hooks are connected with the two strap hook loops to connect the lower ends of the two straps to the two sides near the lower end of the back panel.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective view of a folding pet carrier according to the present disclosure.

FIG. 2 is a rear perspective view of the folding pet carrier according to the present disclosure.

FIG. 3 is a side cross-sectional view of the folding pet carrier according to the present disclosure.

FIG. 4 to FIG. 6 are perspective views showing sequential operation procedures of the folding pet carrier being folded to be stowed according to the present disclosure.

FIG. 7 is a rear perspective view of the folding pet carrier in which a holder and an anti-fouling pad are taken out according to the present disclosure.

FIG. 8 is a perspective view of the folding pet carrier in a shoulder bag mode according to the present disclosure.

FIG. 9 is a perspective view of the folding pet carrier in a wheeled mode according to the present disclosure.

FIG. 10 is an exploded view of the folding pet carrier and a cart used cooperatively with the folding pet carrier according to the present disclosure.

FIG. 11 is a perspective view of the folding pet carrier in a cart mode assembled onto the cart according to the present disclosure.

FIG. 12 is a partially enlarged bottom perspective view of the folding pet carrier in an in-car mode according to the present disclosure.

FIG. 13 is a schematic view of a use state of the folding pet carrier in an in-car mode fixed to a car seat according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

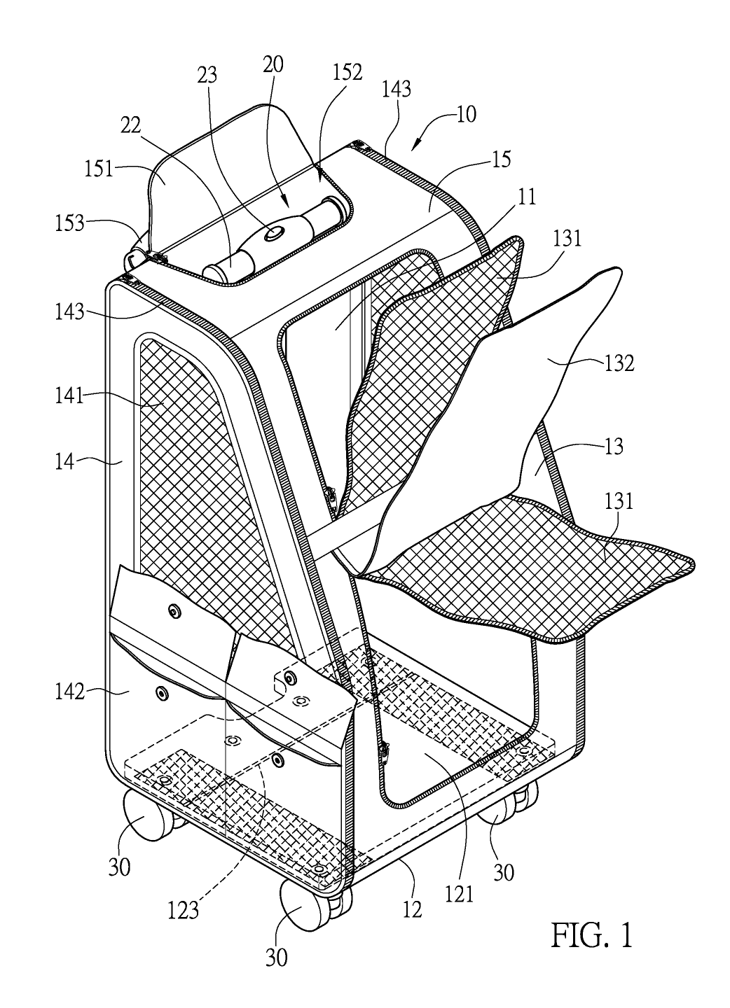

The present disclosure provides a folding pet carrier 10. As shown in FIG. 1 to FIG. 3, the folding pet carrier 10 of the present disclosure includes: a back panel 11, a bottom panel 12, two side panels 14, a front panel 13 and a top surface portion 15. The back panel 11 and the bottom panel 12 have a substantially rectangular plate structure. In a use state shown in FIG. 1, the back panel 11 and the bottom panel 12 are perpendicular to each other, the two side panels 14 are parallel to each other, and edges of the two side panels 14 are respectively connected to two sides of the back panel 11, the bottom panel 12, the top surface portion 15 and the front panel 13, so that the back panel 11, the bottom panel 12, the two side panels 14, the front panel 13 and the top surface portion 15 surroundingly co-define a box structure similar to a pet cage.

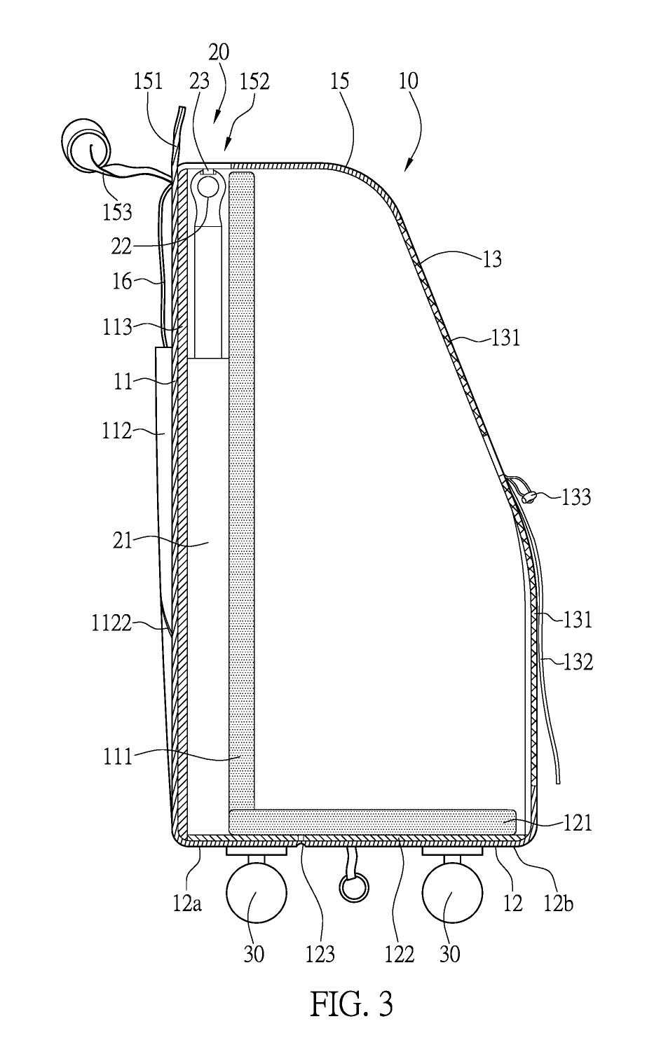

The front panel 13 is disposed with a plurality of air-permeable nets 131, a side edge of each of the plurality of air-permeable nets 131 is connected to the front panel 13 through a suture, the remaining three sides connect to the front panel 13 through a zipper or other equivalent connecting members, so that each air-permeable net 131 is openably disposed on the front panel 13 and a user can selectively cover the air-permeable net 131 on the front panel or unveil the air-permeable net 131 to provide a pet with access or allow the pet to poke its head out. An outer side of one of the air-permeable nets 131 is further disposed with a shielding curtain 132. In FIG. 1 and FIG. 3, the shielding curtain 132 selectively covers the outer side of the air-permeable net 131, or the shielding curtain 132 is rolled up and tightened by a tightening member 133 so that the air-permeable net 131 corresponding to the shielding curtain 132 remains open. The two side panels 14 are also disposed with the plurality of air-permeable nets 141 and a plurality of pockets 142 are respectively disposed on lower sides of the two side panels 14 for the user to store pet supplies, snacks and feed.

In FIG. 3, in the folding pet carrier 10, the back panel 11 and the bottom panel 12 are respectively disposed with reinforcing plates 113 and 122, and the interiors of the two side panels 114 are also provided with a reinforcing structure, so that the back panel 11, the bottom panel 12 and the two side panels 14 are rigid and not easily bendable, and capable of withstanding the weight of the pet. In addition, an inner side surface of the back panel 11 is disposed with a back panel pad 111 and an upper side surface of the bottom panel 12 is disposed with a bottom panel pad 121 for the pet's comfort.

A coupling member 124 is disposed at a position where the bottom panel 12 corresponds to the bottom panel pad 121 to detachably dispose the bottom panel pad 121 on the bottom panel 12. In this embodiment, the coupling member 124 is a Velcro strap. However, in other embodiments of the present disclosure, the coupling member 124 may be replaced by other equivalent members, such as a coupling member of a magnet, a button, or a tether.

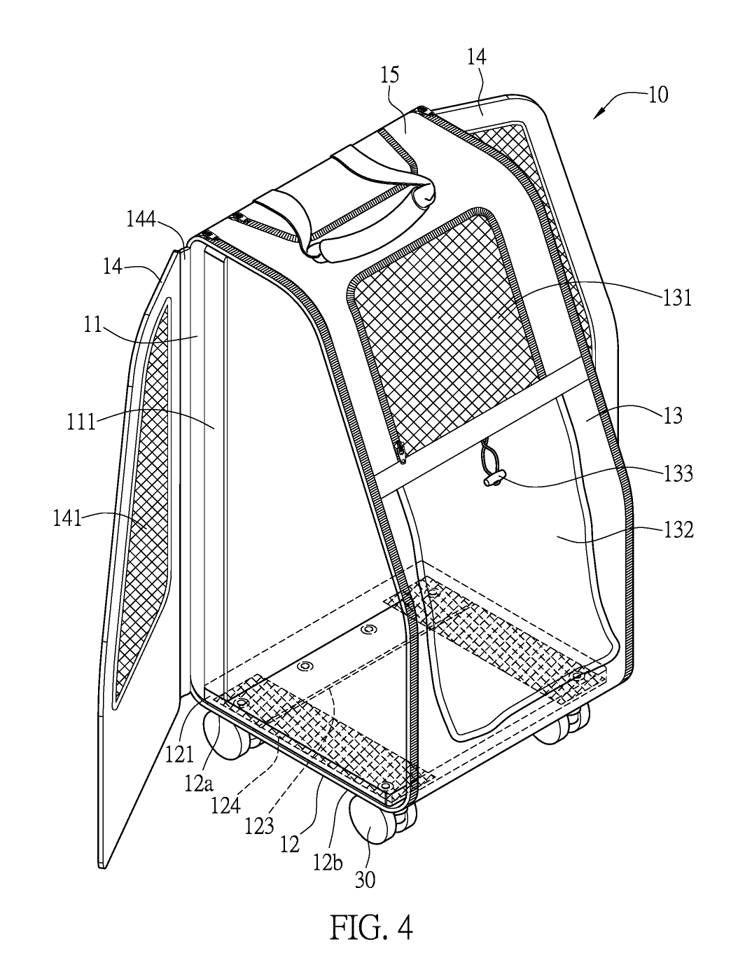

In FIG. 4 to FIG. 6, one of the characteristics of the folding pet carrier 10 of the present disclosure is that when the folding pet carrier 10 is stowed, the folding pet carrier 10 is folded into a plate-like structure to reduce the volume of the folding pet carrier 10 such that the folding pet carrier 10 can be easily carried and can occupy less space during delivery. The folding pet carrier 10 of the present disclosure can be folded and stowed by adopting a design described as follows. The front panel 13 and the top surface portion 15 are made of flexible cloth or a sheet material such that the front panel 13 and the top surface portion 15 are flexible. A flexible connecting portion 14 is disposed between a rear side edge of the two side panels 14 and two corresponding side edges of the back panel 11, so that the two side panels 14 are bendably connected to two opposite side edges of the back panel 11. In addition, a connecting member 143 is respectively disposed between edges of the two side panels 14 and the front panel 13, the bottom panel 12, and the top surface portion 15. In this embodiment, the two connecting members 143 are zippers or other equivalent members such as fastening tapes or metal buckles. The two connecting members 143 may be closed or open, so that the edges of the two side panels 14 may be connected or separated from the two side edges of the front panel 13, the top surface portion 15 and the bottom panel 12.

Furthermore, the bottom panel 12 is bendably connected to an upper end of the back panel 11. In order to enable the bottom panel 12 to be bendable, the bottom panel 12 in this embodiment has a fixed end 12a and a movable end 12b, the fixed end 12a of the bottom panel 12 is connected to a bottom end of the back panel 11, the movable end 12b is connected to a side edge of the fixed end 12a with respect to the back panel 11, a common boundary between the fixed end 12a and the movable end 12b of the bottom panel 12 forms a separation line 123, and the reinforcing plate 122 is cut along a position corresponding to separation line 123 to form a slit, so that the bottom panel 12 is bendable from the separation line 123.

When the user wishes to stow the folding pet carrier 10, the user can fold the folding pet carrier 10 according to FIG. 4 to FIG. 6. First, in FIG. 1 and FIG. 4, the user can pull apart the connecting member 143 at edges of the two side panels 14 to open, so that the edges of the two side panels 14 are separated from the two sides of the bottom panel 12, the front panel 13 and the top surface portion 15.

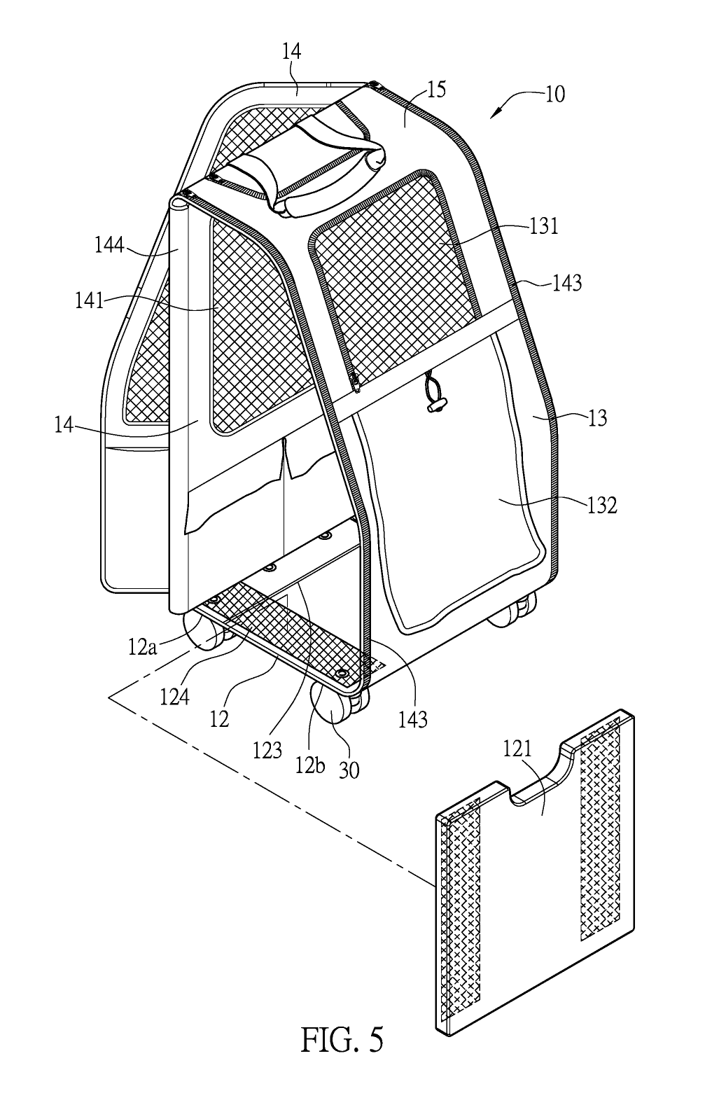

In FIG. 5, the user can unveil the two side panels 14 from the two side edges of the folding pet carrier 10, take out the bottom panel pad 121 from the bottom panel 12, and bend the two side panels 14 toward the front side surface or the rear side surface of the back panel 11. Specifically, in this embodiment, when the folding pet carrier 10 is folded and stowed, one of the two side panels 14 is folded against the front side surface of the back panel 11, and another of the two side panels 14 is folded against the rear side surface of the back panel 11. In the above arrangement, when the two side panels 14 are folded against the surface of the back panel 11, the two side panels 14 are not overlapped with each other.

However, in other embodiments, the way of folding the two side panels 14 may be stacking the two side panels 14 together on the same side surface of the back panel 11, and the present disclosure is not limited to the way of folding illustrated in FIG. 5.

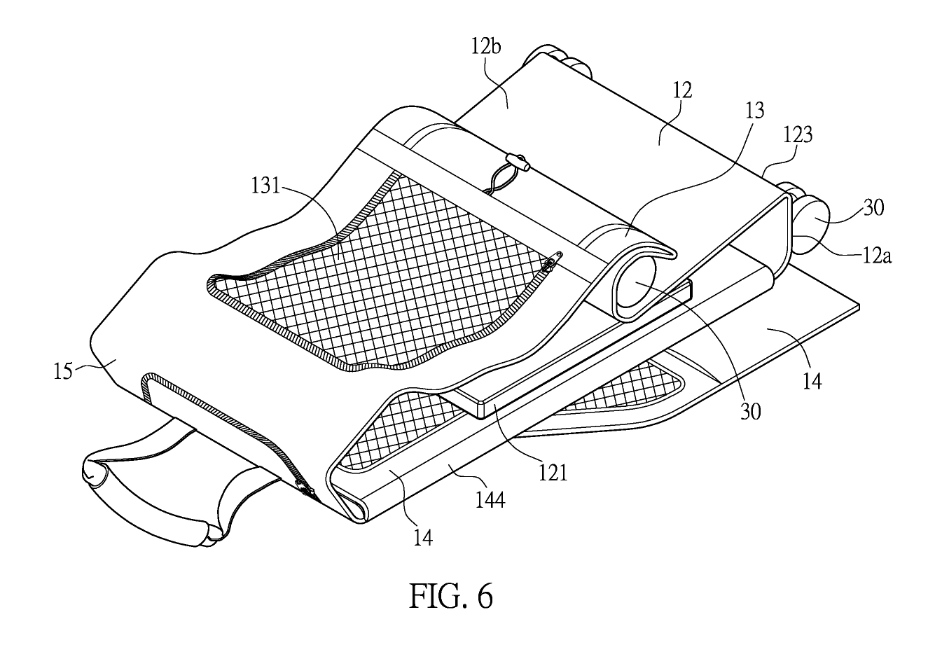

In FIG. 6, after the two side panels 14 are folded against the back panel 11, the user further bends the movable end 12b toward the back panel 11, so that the movable end 12b is in close contact with the back panel 11. Then, the user folds the front panel 13 and the top surface portion 15 on the surface of the back panel 11 and the bottom panel 12 and the side panel 14, such that the folding pet carrier 10 of the present disclosure can be folded and stowed.

The folding pet carrier 10 is designed to be used in many ways, such as carrying by hand, carrying on the back, wheeling on the ground or putting on a cart to be pushed. Further, the folding pet carrier 10 of the present disclosure can be fixed on a cart seat.

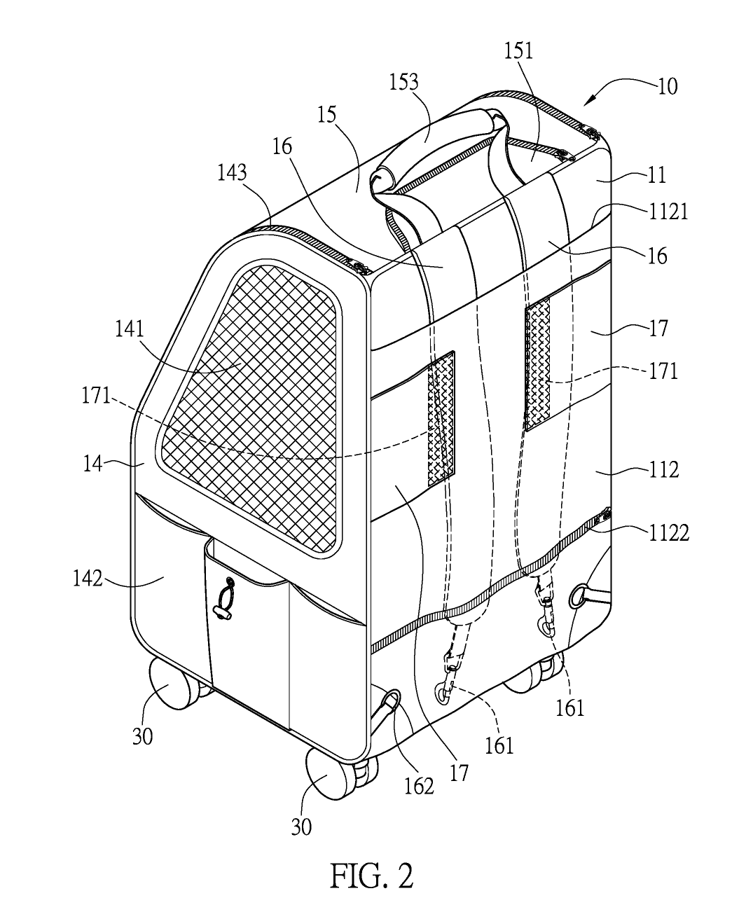

In FIG. 1 and FIG. 2, the rear side of the top surface portion 15 or the upper side edge of the back panel 11 is connected to a handle 153. With the handle 153, the user can easily carry the folding pet carrier 10 and can move the folding pet carrier 10 of the present disclosure by hand.

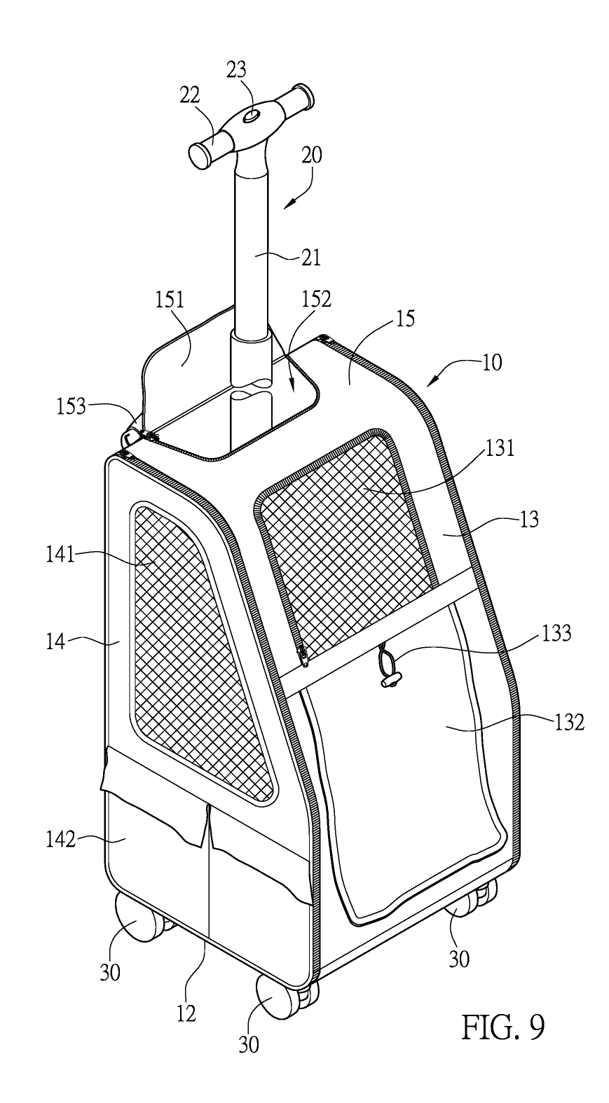

In FIG. 1, FIG. 3 and FIG. 9, the folding pet carrier 10 is disposed with a plurality of rollers 30 on the bottom panel 12 and a lever device 20 at the back panel 11, so that the user can easily push the folding pet carrier 10 of the present disclosure to wheel on the ground. As shown in FIG. 3, in this embodiment, a gap between the back panel pad 111 and the inner side surface of the back panel 11 and a lever device 20 is disposed in the gap between the back panel pad 111 and the inner side surface of the back panel 11. The lever device 20 includes: a telescopic rod body 21 and a handle portion 22 disposed at an upper end of the telescopic body 21. The telescopic rod body 21 is a multi-section extendable sleeve made of metal or engineering plastic. The telescopic body 21 and the back panel pad 111 are disposed at the inner side surface of the back panel 11 in parallel, and the telescopic rod body 21 is extendable or contractible along a direction parallel to the back panel 11. The handle portion 22 is disposed at an upper end of the telescopic rod body 21 and can change its height position as the telescopic rod body 21 extends or contracts. The handle portion 22 is disposed with a control button 23, the control button 23 is linked with a latching device (not shown) disposed in the telescopic rod body 21 for the user to control the latching device to be in a released state or a locked state. When the latching device is in the released state, the telescopic rod body 21 can extend or contract, and when the latching device is in the locked state, the latching device engages with the telescopic rod body 21 to fix the telescopic rod body 21 at a specific length.

When the telescopic rod body 21 contracts, the height of the handle portion 22 of the upper end of the lever device 20 is lower than the height of the top surface portion 15 of the folding pet carrier 10, so that the lever device 20 may be hidden in the gap between the back panel pad 111 and the inner side surface of the back panel 11. The top surface portion 15 of the folding pet carrier 10 is further disposed with a shielding plate 151 and an opening portion 152. The position of the opening portion 152 corresponds to the lever device 20 and the width and height of the opening portion 152 cooperate with the handle portion 22 of the lever device 20. When the telescopic rod body 21 extends, the telescopic rod body 21 and the handle portion 22 extend from the opening portion 152 to the outer side of the top surface portion 15. A side edge of the shielding plate 151 is connected to the upper side edge of the back panel 11. Also, as shown in FIG. 2, the shielding plate 151 selectively covers the opening portion 152 or the shielding plate 151 is unveiled so that the opening portion 152 is open. The shielding plate may further be disposed with a connecting member or other fasteners to connect the edges of the shielding plate 151 with the edges of the opening portion 152 when the shielding plate 151 covers the opening portion 152.

In FIG. 9, when the folding pet carrier 10 is used in a wheeled mode, the bottom panel 12 of the folding pet carrier 10 faces the ground, the plurality of rollers 30 on the bottom panel contact the ground, the shielding plate 151 is opened and the lever device 20 is extended, so that the telescopic rod body 21 and the handle portion 22 extend to the outer side of the top surface portion 15 of the folding pet carrier 10.

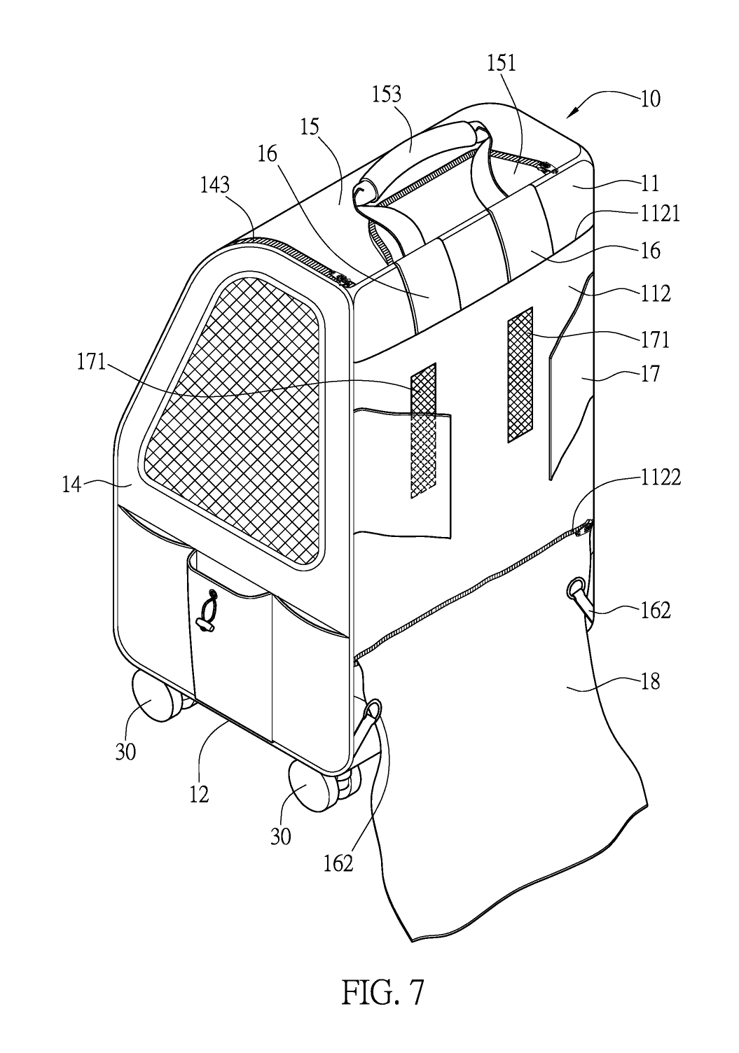

In FIG. 2 and FIG. 7, the outer side surface of the back panel 11 of the folding pet carrier 10 is disposed with an interlayer portion 112. The interlayer portion 112 is formed by cloth sewn on the outer side surface of the back panel 11. The upper end edge of the interlayer portion 112 is not sewn to the back panel to form an interlayer opening 1121. The interlayer portion 112 is provided with an interlayer slit 1122. The interlayer slit 1122 is disposed with a zipper or other equivalent connecting members. When the zipper of the interlayer slit 1122 is pulled apart, the interlayer slit is open.

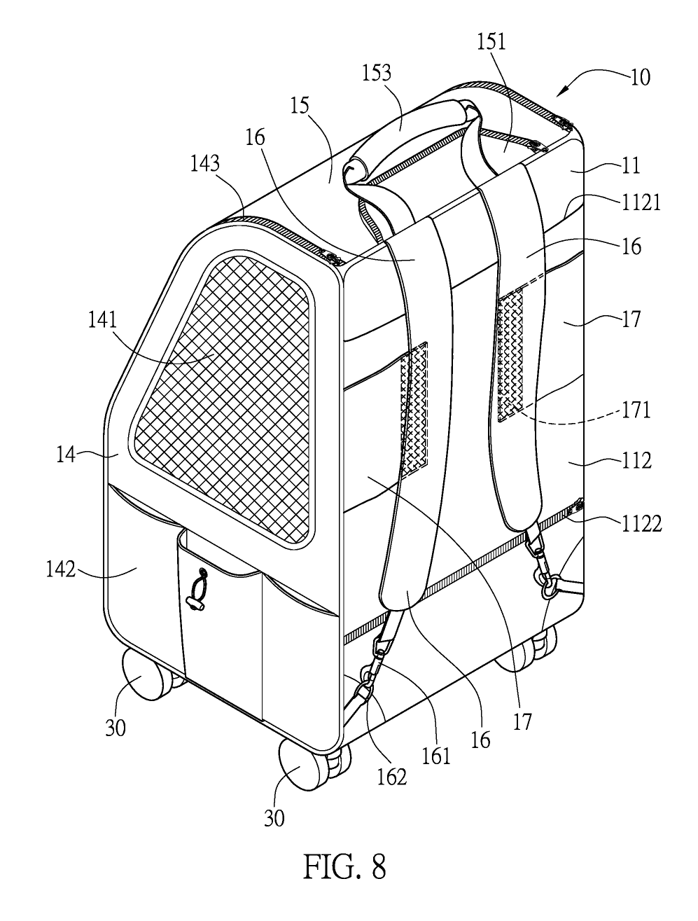

In FIG. 2 and FIG. 8, the rear surface of the folding pet carrier 10 is disposed with two straps 16, two holders 17 and an anti-fouling pad 18. The upper ends of the two straps 16 are connected to the upper side edge of the back panel 11. The lower ends of the two straps 16 are respectively disposed with a strap hook 161 and two strap hook loops 162 are respectively disposed at two sides of the lower side edge of the back panel 11. In FIG. 2, when the two straps 16 are not in use, the strap hooks 161 of the two straps 16 are not connected to the strap hook loops 162, and the two straps 16 can be inserted in the gap between the interlayer portion and the outer side surface of the back panel 11. In FIG. 8, when the folding pet carrier 10 of the present disclosure is used in a shoulder bag mode, the user can remove the two straps 16 from the interlayer portion 112 and connect the two strap hooks 161 with the two strap hook loops 162 to connect the upper ends of the two straps 16 to the two sides of the upper side edge of the back panel 11, such that the user can put their arms through the two straps 16 so that the folding pet carrier 10 can be carried on the shoulders of the user.

In FIG. 7, the folding pet carrier 10 of the present disclosure further has the two holders 17. The two holders 17 are made of a flexible sheet material, such as cloth, a film or a composite sheet material. The two holders 17 have a side defined as a fixed end near the back panel 11, and the fixed ends of the two holders 17 are connected to side edges of two opposite longer sides of the back panel 11 by sewing. The two holders 17 have another side edge with respect to the back panel 11 defined as a movable end. A holder fastener 171 is respectively disposed between the movable ends of the two holders 17 and the back panel 11. With the two holder fasteners 171, the movable ends of the two holders 17 can be selectively combined on the rear surface of the back panel 11 or can be torn from the rear surface of the back panel 11 to be movable.

The main function of the two holders 17 is to fix the folding pet carrier 10 of the present disclosure onto a cart 40 to facilitate the use of the folding pet carrier 10 on the cart.

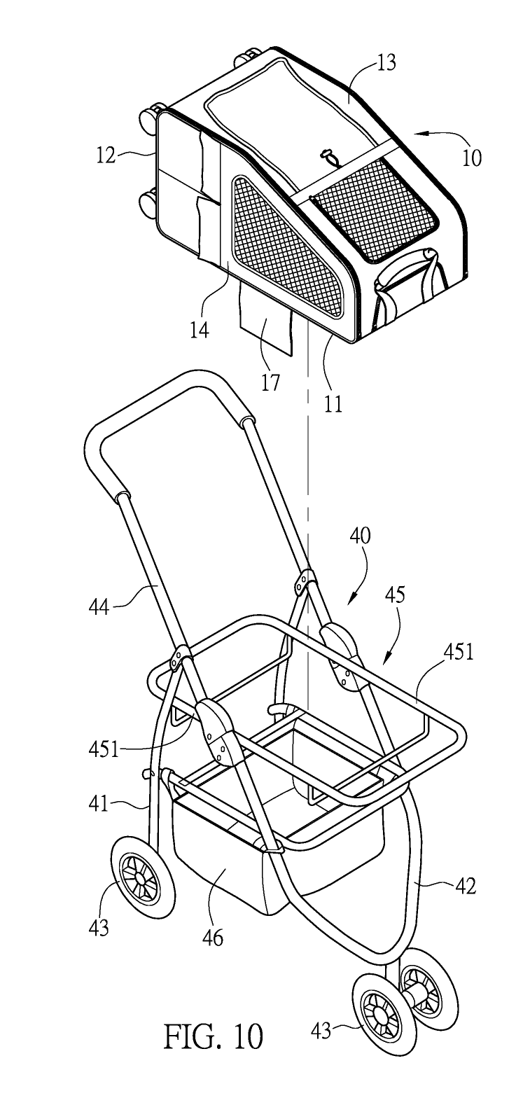

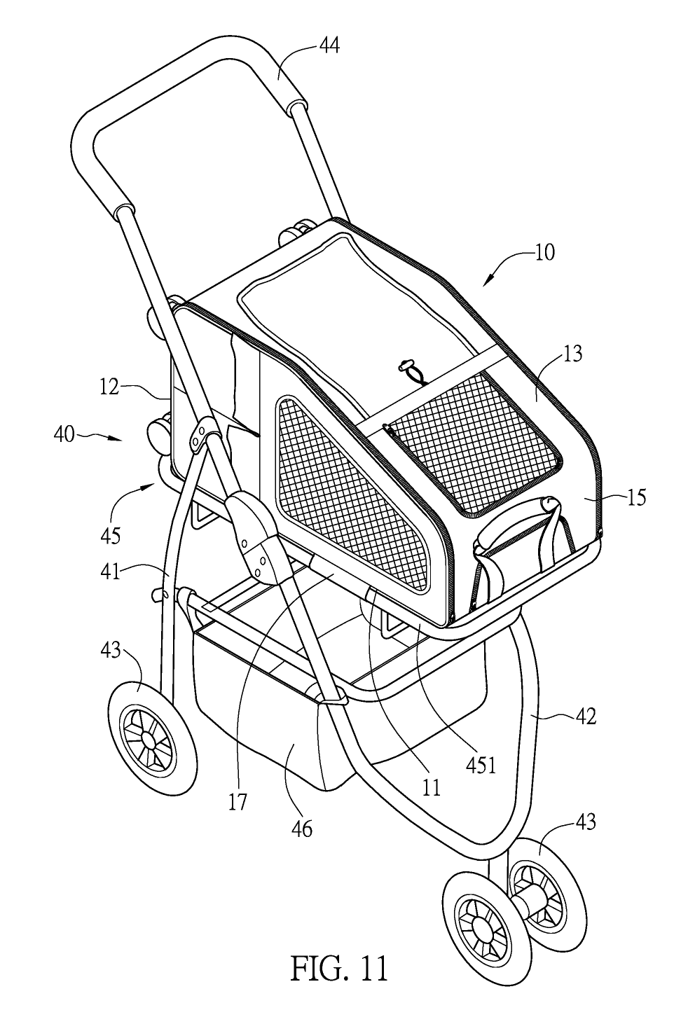

In FIG. 10 and FIG. 11, the folding pet carrier 10 can be combined with the cart 40 in use. The cart 40 includes a rear frame body 41 and a front frame body 42 which are foldable and connected with each other. The lower ends of the front frame body 42 and the rear frame body 11 are disposed with a plurality of cart rollers 43 and the upper end of the rear frame body 41 is pivotally connected to the middle of the front frame body 42. The upper end of the front frame body 42 extends in a direction opposite to the cart rollers 43 to form a cart handle 44, a horizontal frame 45 is connected to the front frame body 42 and the rear frame 41 at a position close to a waist height of the user, and a basket 46 is located under the horizontal frame 45. The horizontal frame 45 has two side rods 451 parallel to each other.

A distance between the two side rods 451 of the horizontal frame 45 is equal to or less than a width of the two opposite longer sides of the back panel 11 of the folding pet carrier 10, such that the back panel 11 of the folding pet carrier 10 can be placed above the horizontal frame 45 and supported by the horizontal frame 45. The two holders 17 are disposed at the two side edges of the back panel 11 corresponding to the two side rods 451. When the folding pet carrier 10 of the present disclosure is placed on the cart 40, the back panel 11 of the folding pet carrier 10 faces downward, the user tears the two holders 17 on the two opposite longer sides of the back panel 11 to cover the two side rods 451 of the horizontal frame 45, and attach the movable ends of the holders 17 on the holder fasteners 171, so that the two holders 17 can be tightened up on the two side rods 451 to fix the folding pet carrier 10 on the horizontal frame 45, and the user can easily push the folding pet carrier 10 around via the cart 40.

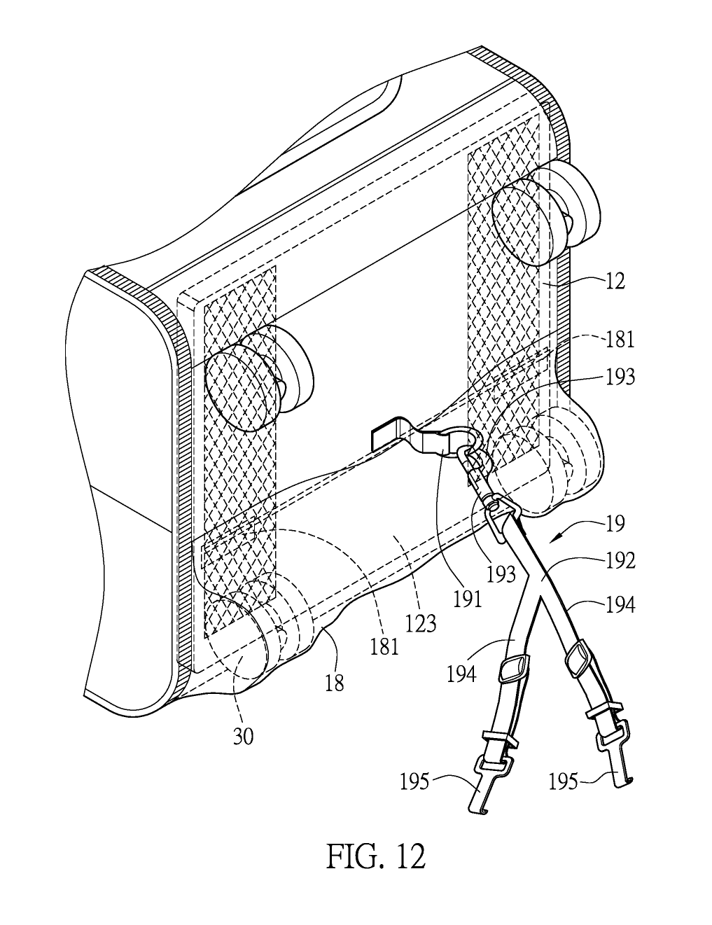

In FIG. 7 and FIG. 12, the anti-fouling pad 18 is made of waterproof cloth, textile, or a film such as tarpaulin or non-woven fabric. An end of the anti-fouling pad 18 is a fixed end and the fixed end of the anti-fouling pad is connected to the back panel 11 of the carrier 10 near the interlayer slit 1122 by sewing or pasting. In FIG. 4, when the anti-fouling pad 18 is not in use, the anti-fouling pad 18 can be placed in the gap between the interlayer portion and the outer side surface of the back panel 11 from the interlayer slit 1122 to hide the anti-fouling pad 18 in the interlayer portion 112. When the interlayer slit 1122 is open, a movable end of the anti-fouling pad 18 can be pulled out from the interlayer slit 1122. In FIG. 12, when the anti-fouling pad 18 is in use, the movable end of the anti-fouling pad 18 can be pulled out from the interlayer slit 1122 and at least cover the bottom half of the outer side surface of the bottom panel 12 and the outer side of the two rollers 30 near the back panel 11. In addition, at least two anti-fouling pad fasteners 181 are disposed between the movable end of the anti-fouling pad 18 and the bottom surface of the bottom panel 12. The movable end of the anti-fouling pad 18 is fixed on the bottom surface of the bottom panel 12 by the anti-fouling pad fasteners 181.

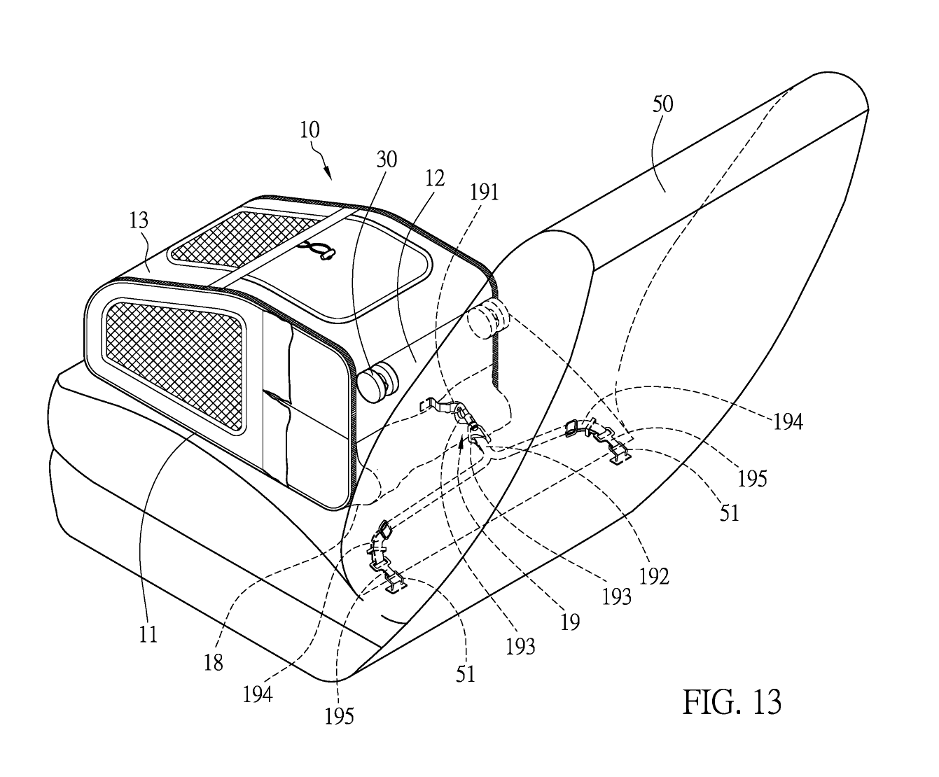

In FIG. 12 and FIG. 13, when the folding pet carrier 10 is used in an in-car mode, the back panel 11 of the folding pet carrier 10 abuts against a car cushion of a car seat 50, and the bottom panel 12 is placed on the car seat 50 towards the back of the car seat 50. The bottom panel 12 of the folding pet carrier 10 can further be connected to a safety seat buckle 51 of the car seat 50 via a safety seat belt 19 to prevent the folding pet carrier 10 from slipping off the car seat 50 while the car is moving. In the in-car mode, the user can pull out the anti-fouling pad 18 from the interlayer slit 1122 to cover the bottom panel 12 and the rollers 30 to protect the car seat from the dust on the rollers 30 and the bottom panel 12.

In FIG. 13, the safety seat belt 19 includes a belt 192 and two branch belts 194. An end of the belt 192 is simultaneously connected to an end of the two branch belts 194 to form a Y-shape. An end of the belt 192 opposite to the two branch belts 194 is disposed with a belt hook loop 193. The belt hook loop 193 is connected to a bottom buckle 191 of the bottom surface of the bottom panel 12 disposed at the folding pet carrier 10, so that the belt 192 is connected to the bottom panel 12 of the folding pet carrier 10. An end of the two branch belts 194 opposite to the belt 192 is disposed with a buckle member 195. The two buckle members 195 buckle the safety seat buckle 51 (such as an ISOFIX buckle) on the car seat 50 so that the folding pet carrier 10 can be fixed on the car seat 50 by the safety seat belt 19.

In conclusion, the beneficial effect of the present disclosure is that the folding pet carrier 10 of the present disclosure can be used in a plurality of modes, and the user can choose between different modes depending on different environments or circumstances. In addition, the folding pet carrier 10 of the present disclosure is foldable. When the folding pet carrier 10 of the present disclosure is not in use, the user can easily fold the folding pet carrier 10 to a shape close to a flat plate, which is space-saving and convenient to be delivered.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A folding pet carrier, comprising:
a back panel, a bottom panel, a front panel, a top surface portion and two side panels; wherein the back panel, the bottom panel, the front panel, the top surface portion and the two side panels surroundingly define an accommodating space;
wherein the two side panels are connected to two opposite side edges of the back panel, and the two side panels and the two side edges of the back panel are connected via a bendable connecting portion to allow the two side panels to be bent from the position of the connecting portion;
wherein the bottom panel is bendably connected to the bottom of the back panel;
wherein the front panel and the top surface portion are formed of flexible cloth or a sheet material to allow the front panel and the surface portion to be foldable;
wherein a connecting member is respectively disposed between edges of the two side panels and the bottom panel, the front panel and the top surface portion, and a user closes or opens the two connecting members; when the two connecting members are closed, the edges of the two side panels and the bottom panel, the front panel and the top surface portion are connected with each other via the two connecting members; when the two connecting members are open, the edges of the two side panels and the bottom panel, the front panel and the top surface portion are separated, allowing the two side panels, the bottom panel, the top surface portion and the front panel to be stacked on the back panel, allowing the folding pet carrier to be stowed.

2. The folding pet carrier according to claim 1, wherein the two connecting members are zippers.

3. The folding pet carrier according to claim 2, wherein the bottom panel has a fixed end and a movable end, the fixed end of the bottom panel is connected to a bottom end of the back panel, the movable end of the bottom panel is connected to a side edge of the fixed end with respect to the back panel, and a common boundary between the fixed end and the movable end of the bottom panel forms a separation line to allow the movable end and the fixed end of the bottom panel to be relatively bent from the separation line.

4. The folding pet carrier according to claim 3, further comprising:
a lever device disposed at an inner side surface of the back panel and including a telescopic rod body and a handle portion disposed at an upper end of the telescopic body, wherein the telescopic rod body and the back panel pad are disposed at the inner side surface of the back panel in parallel, and the telescopic rod body is extendable or contractible along a direction parallel to the back panel; when the telescopic rod body contracts, the height of the upper end of the telescopic rod body and the handle portion is lower than the height of the top surface portion and hidden under the top surface portion; when the telescopic rod body extends, the upper end of the telescopic rod body and the handle portion extend to the outer side of the top surface portion;
a plurality of rollers disposed on the bottom surface of the bottom panel, wherein the plurality of rollers are in contact with the ground to allow the folding pet carrier to be wheeled on the ground; and
two straps, wherein an upper end of the two straps is connected to an upper side edge of the back panel, a strap hook is disposed at a lower end of the two straps respectively, two strap hook loops are respectively disposed at two sides of the outer side surface of the back panel near a lower end of the back panel, the two strap hooks are connected with the two strap hook loops to connect the lower ends of the two straps to the two sides of the outer side surface of the back panel near the lower end of the back panel.

5. The folding pet carrier according to claim 4, wherein an interlayer portion is disposed at the outer side surface of the back panel, the interlayer portion is attached against the outer side surface of the back panel, an interlayer opening is formed between the upper side edge of the interlayer portion and the back panel, and the lower ends of the two straps are inserted from the interlayer opening into a gap between the interlayer portion and the outer side surface of the back panel.

6. The folding pet carrier according to claim 5, wherein the inner side surface of the back panel is disposed with a back panel pad, the inner side surface of the bottom panel is disposed with a bottom panel pad, and the lever device is accommodated in the gap between the back panel pad and the inner side surface of the back panel.

7. The folding pet carrier according to claim 6, wherein a shielding plate and an opening portion are disposed at the top surface portion corresponding to a position above the lever device, and the shielding plate selectively covers the opening portion or the shielding plate is unveiled to allow the opening portion be open; when the telescopic rod body of the lever device contracts, the shielding plate covers the opening portion to hide the lever device under the shielding plate; when the shielding plate is unveiled to allow the opening portion to be open, the telescopic rod body and the handle portion extend to the outer side of the top surface portion.

8. The folding pet carrier according to claim 5, further comprising a cart, wherein the cart has a foldable frame body, a plurality of cart rollers and a horizontal frame disposed on the frame body, and the folding pet carrier is disposed on the cart in such a manner that the back panel is attached against the horizontal frame.

9. The folding pet carrier according to claim 8, wherein the horizontal frame has two side rods, and the width of the two side edges of the back panel is equal to or greater than the spacing between the two side rods; a holder is respectively disposed on two side edges of the back panel corresponding to the side rods; when the folding pet carrier is placed on the horizontal frame, the two holders cover the two side rods to fix the folding pet carrier onto the horizontal frame.

10. The folding pet carrier according to claim 9, wherein the two holders are made of a flexible sheet material, an end of the two holders is connected to the two side edges of the back panel, and a movable end of the two holders with respect to the back panel is combined at the outer side surface of the back panel through two holder fasteners.

11. The folding pet carrier according to claim 5, wherein the folding pet carrier is placed on a car seat in such a manner that the back panel is attached against a seat cushion of the car seat, and is fixed on the car seat by connecting a safety seat belt to a safety seat buckle of the car seat; wherein the safety seat belt includes a belt, an end of the belt is connected to a belt buckle, and through the belt buckle connected to a bottom buckle disposed on the outer side surface of the bottom panel, an end of the belt with respect to the belt buckle is connected to two branch belts, an end of the two branch belts with respect to the belt respectively is connected to a buckle member, and connected to the safety seat buckle through the two buckle members.

12. The folding pet carrier according to claim 11, wherein an interlayer slit is disposed at the interlayer portion near the lower side edge of the back panel, the interlayer portion is disposed with an anti-fouling pad, a fixed end of the anti-fouling pad is connected to the back panel, a movable end of the back panel passes through the interlayer slit and covers the bottom panel and the outer side surfaces of the plurality of rollers, and the movable end of the anti-fouling pad is combined to the outer side surface of the bottom panel through an anti-fouling pad fastener.
